(19) United States
(12) Patent Application Publication
(10) Pub. No.: US 2024/0377283 A1
(43) Pub. Date: Nov. 14, 2024

(54) DEVICE FOR PREDICTING THE EVOLUTION OF A DEFECT OF A BEARING, ASSOCIATED SYSTEM AND METHOD

(71) Applicant: AKTIEBOLAGET SKF, GOTEBORG (SE)

(72) Inventors: Mourad CHENNAOUI, Amsterdam (NL); Christine MATTA, Utrecht (NL); Alireza AZARFAR, Utrecht (NL); Guillermo Enrique MORALES ESPEJEL, Ijsselstein (NL); Xiaobo Zhou, Houten (NL)

(21) Appl. No.: 18/687,351

(22) PCT Filed: Aug. 12, 2022
(86) PCT No.: PCT/EP2022/072646

§ 371 Date: Feb. 28, 2024

(30) Foreign Application Priority Data
Sep. 8, 2021 (DE) 10 2021 209 880.0

(51) Int. Cl. G01M 13/04; G01N 21/88; G06T 7/00

(52) U.S. Cl. CPC G01M 13/04; G01N 21/8851; G06T 7/001; G01N 2021/8883; G06T 2207/20081; G06T 2207/20084

(57) ABSTRACT

A method for predicting the evolution of a defect of a bearing includes identifying a defect of the bearing and extracting geometrical parameters of the identified defect by a trained deep learning algorithm from a picture of the bearing and further includes predicting an evolution of the identified defect of the bearing from a type of the identified defect and the extracted geometrical parameters of the identified defect, from operating parameters of the bearing and from a model of the bearing. Also a device for performing the method.

The present invention is directed to predicting the evolution of a defect of a bearing.

The present invention concerns in particular a method, a device and a system for predicting the evolution of a defect of a bearing.

In order to guide a mechanical assembly in rotation, it is generally proposed to use rolling bearings equipped with rolling elements rolling on raceways of the bearings.

Visual inspections of rolling elements are performed on the bearing to detect a defect leading to the deterioration of the bearing and to plan predictive maintenance operations.

A defect may be spalls of the raceways of the bearing.

Generally visual inspections comprise taking pictures of the bearing and interpreting the pictures by an expert.

The expert may predict the evolution of the defects according for example to the number of cycles from his interpretation of the pictures and his knowledge.

From his predictions, the expert makes recommendations.

The recommendations may comprise planning preventive maintenance operations for example to change the bearing or remanufacturing the bearing.

Visual inspections remain a manual process that relies on the expertise of experts and takes time.

The experts may no be located on site so that the bearing must be sent extending the duration of unavailability of a machine incorporating the bearing.

However, the expert may be wrong in his interpretation of the pictures leading to an inconsistent defect analysis when a group of experts interpret the pictures, and to inconsistent recommendations.

Various surface features such as oil residues, scratches, lighting reflections and/or other bearing parts may mislead the expert in his interpretation of the pictures.

It is known to train a neuronal network to identify defects from pictures taking into account various surface features.

However, the trained neuronal network only identifies defects and does not predict the evolution of the defect.

Consequently, the present invention intends to overcome these disadvantages.

According to an aspect, a method for predicting the evolution of a defect of a bearing.

The method comprises:
identifying a defect of the bearing and extracting geometrical parameters of the identified defect by a trained deep learning algorithm from a picture of the bearing, and
predicting the evolution of the identified defect of the bearing from the type of the identified defect and the extracted geometrical parameters of the identified defect, operating parameters of the bearing and a model of the bearing.

The method permits to detect and to predict, in an automated way, the evolution of a various type of defects of the bearing without the intervention of an expert by taking into account oil residues, scratches, lighting reflections and/or other bearing parts to obtain accurate classification of defects.

Preferably, the method further comprises generating a recommendation according to the predicated evolution of the identified defect.

The generated recommendation permits to support efficiency, quickly and easily the user of the bearing for example by planning preventive maintenance operations.

Advantageously, the method comprises before identifying a defect, taking the picture of the bearing mounted in a machine.

The detection of the defect is made on site, the bearing needs not to be sent for example in an expertise centrum.

Preferably, the defect comprises a spall, the extracted geometrical parameters comprise the size of the spall, the perimeter of the spall and the localisation of the spall on the picture.

Advantageously, the deep learning algorithm comprises a neuronal network, wherein the method comprises training the neuronal network to identify the defect of the bearing and to extract geometrical parameters of the identified defect from pictures stored in a reference data base.

According to another aspect, a device for predicting the evolution of a defect of a bearing is proposed.

The device comprises:
implementing means configured to implement a trained deep learning algorithm to identify a defect of the bearing and to extract geometrical parameters of the identified defect from a picture of the bearing, and
predicting means configured to predict the evolution of the identified defect of the bearing from the type of identified defect and the extracted geometrical parameters of the identified defect, from operating parameters of the bearing and from a model of the bearing.

Preferably, the deep learning algorithm comprises a neuronal network, the device further comprising training means configured to train the neuronal network to identify the defect of the bearing and to extract geometrical parameters of the identified defect from pictures stored a reference data base.

Advantageously, the device further comprises generating means configured to generate a recommendation according to the predicated evolution of the identified defect.

According to another aspect, a system for predicting the evolution of a defect of a bearing is proposed

The system comprises a device as defined below and a mobile device configured to take the picture of the bearing mounted in a machine and communicating wirelessly with the device.

Other advantages and features of the invention will appear on examination of the detailed description of embodiments, in no way restrictive, and the appended drawings in which:

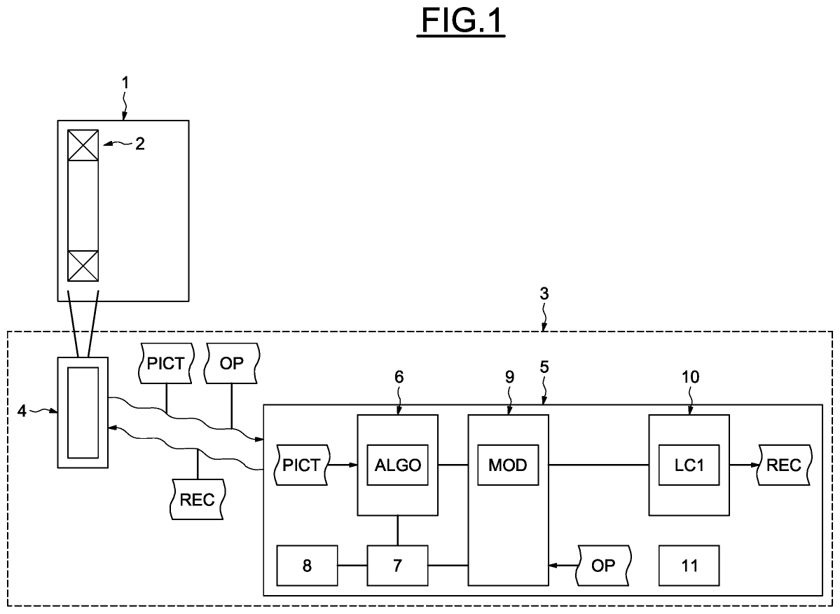

FIG. 1 illustrates schematically a system for predicting the evolution of a defect of a bearing in a machine according to the invention;

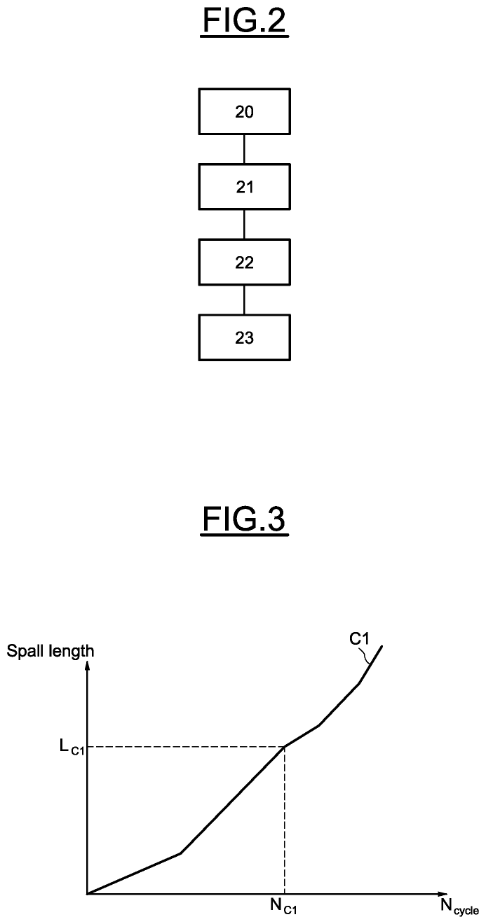

FIG. 2 illustrates an example of a method for predicting the evolution of a defect of a bearing according to the invention; and

FIG. 3 illustrates an example of a prediction of a spall evolution according to the invention.

Reference is made to FIG. 1 which represents an example of a machine 1 comprising a bearing 2 and a system 3 for predicting the evolution of a defect of the bearing 2.

The system 3 comprises a mobile device 4 taking pictures PICT of the bearing 2 mounted in the machine 1 and a device 5 for predicting the evolution of a defect of the bearing 2.

The device 4 communicates wirelessly with the device 5 to exchange data.

The mobile device 3 may be a smartphone communicating wirelessly with the system 4.

As a variant, the mobile device 3 may be a device configured to take picture and to communicate wirelessly with the system 4.

In another embodiment, the system 4 may be incorporated in the mobile device 3.

The device 5 comprises implementing means 6 implementing a trained deep learning algorithm ALGO to identify a defect of the bearing and to extract geometrical parameters of the identified defect from a picture of the bearing 2.

The deep learning algorithm ALGO may comprise a neuronal network and the device 5 may comprise training means 7 to train the neuronal network to identify the defect of the bearing 2 and to extract geometrical parameters of the identified defect from pictures stored in a reference data base 8.

Pictures are stored in the reference data base 8 over the identification of defects of the bearing 2 and extraction of geometrical parameters to enhance the accuracy of the neuronal network to detect defects.

The training means 7 may further comprise evaluating means to evaluate the accuracy of the defect identification and parameters extraction of the neuronal network by comparing the results of the neuronal network to known results (validation set).

The device 5 further comprises predicting means 9 comprising a model MOD of the bearing 2.

The predicting means 9 predict the evolution of the identified defect of the bearing 2 from the type of identified defect and the extracted geometrical parameters of the identified defect delivered by the implementing means 6, from the operating parameters OP of the bearing 2 and from the model MOD of the bearing 2.

An example of the model MOD is presented in the following.

The operating parameters OP are transmitted to the device 5 by the mobile device 4.

In another embodiment, the operating parameters OP are stored in a data base of the device 5.

The operating parameters OP comprise at least one of the temperature of the bearing, the load of the bearing, the rotating speed of the bearing, the type of lubricant, the moisture in the bearing and the number of cycles of the bearing 2.

The operating parameters may be measured by sensors on the machine 1.

The device 5 further comprise generating means 10 generating recommendations REC according to the predicated evolution of the identified defect delivered by the predicting means 9.

The generating means 10 comprise a predetermined critical value Lc1 depending on the type of the bearing 2 and on the type of identified defects.

The generating means 10 may comprise a set of predetermined critical values according to the number of detected defects and the kind of defects.

The recommendations REC are transmit to the mobile device 4.

The recommendations REC comprise for example an estimated number of bearing cycles before the bearing 2 needs to be changed or remanufactured so that an operator can plan maintenance operations to change the bearing 2.

The device 5 further comprises a processing unit 11 to implement the implementing means 6, the training means 7, the predicting means 9, the generating means 10 and to communicate with the mobile device 4.

FIG. 2 illustrates an example of a method for predicting the evolution of a defect of a bearing 2.

It is assumed that defect comprises spall of a raceway of the bearing 2 and the neuronal network is trained

In another embodiment, defects of the bearing 2 comprise other types of defects.

During a step 20, the mobile device 4 takes one or more pictures of the bearing 2, and sends the pictures PICT and the operating parameters OP to the device 5.

In step 21, the implementing means 6 implement the algorithm ALGO comprising the trained neuronal network to identify the spall from the pictures PICT and to extract geometrical parameters of the identified spall comprising the size of the spall, the perimeter of the spall and the localisation of the spall on the pictures PICT.

In step 22, the type of identified defect, in this case the spall, and the geometrical parameters of the identified spall are transmitted to the predicting means 9.

The model MOD of the predicting means 9 comprises in the case of a spall, a model the predict the spall progression in the bearing 2 according to the operational parameters OP.

The model MOD in the case of a spall is based on empirical data and numerical models such as published in article “Propagation of Large Spalls in Rolling Bearings”, G Morales-Espejel, P. Engelen, G. van Nijien, Tribology Online, Vol. 14, No. 5 254-266, ISSN 1881-2198.

FIG. 3 illustrates an example of a prediction of the spall evolution outputted by the predicting means 9.

The output of the predicting means 9 is represented by a curve Cl representing the evolution of the spall length according to the number of cycles N_{cycle} of the bearing 2.

The output of the predicting means 9 may be a table comprising two columns linking the spall length to the number of cycles N_{cycle}.

In step 23, the generating means 10 compare the curve Cl to the predetermined critical value Lc1 for example a predetermined critical spall length.

The generating means 10 may generate recommendations REC comprising a message to indicate that the bearing 2 should be changed when the bearing 2 has reached a number of cycles Nc1 corresponding to a predicted spall length equal to the predetermined critical value Lc1 (FIG. 3).

The generated recommendations REC permit to support efficiency, quickly and easily the user of the machine 1.

The recommendations REC are transmitted by the processing unit 11 to the mobile device 4.

In another embodiment of the method, the processing unit 11 transmits the output of the predicting means 9 to the mobile device 4.

The device 5 permits to detect and predict the evolution of a various type of defects of the bearing 2 without the intervention of an expert, in an automated way, and to make recommendations about the service life of the bearing 2 for example by predicting when the bearing 2 should be changed so that predictive maintenance operations can be planned.

Planning predictive maintenance operations at the right moment permits to increase the availability rate of the machine 1.

The device 5 interprets the pictures of the bearing 2 by taking into account oil residues, scratches, lighting reflections and/or other bearing parts to obtain accurate classification of defects.

1. A method for predicting the evolution of a defect of a bearing comprising:
identifying a defect of the bearing and extracting geometrical parameters of the identified defect by a trained deep learning algorithm from a picture of the bearing and
predicting an evolution of the identified defect of the bearing from a type of the identified defect and the extracted geometrical parameters of the identified defect, from operating parameters of the bearing and from a model of the bearing.

2. The method according to claim 1, further comprising generating a recommendation based on the predicated evolution of the identified defect.

3. The method according to claim 1, wherein the picture of the bearing is a picture of the bearing mounted in a machine.

4. The method according to claim 1,
wherein the defect comprises a spall, and
wherein the extracted geometrical parameters comprise a size of the spall, a perimeter of the spall and a location of the spall on the picture.

5. The method according to claim 1,
wherein the deep learning algorithm comprises a neuronal network, and
wherein the method further includes training the neuronal network to identify the defect of the bearing and to extract the geometrical parameters of the identified defect from pictures stored in a reference data base.

6. A device for predicting an evolution of a defect of a bearing comprising:
implementing means configured to implement a trained deep learning algorithm to identify a defect of the bearing and to extract geometrical parameters of the identified defect from a picture of the bearing, and
predicting means configured to predict the evolution of the identified defect of the bearing from a type of identified defect and the extracted geometrical parameters of the identified defect, from operating parameters of the bearing and from a model of the bearing.

7. The device for predicting according to claim 6, wherein the deep learning algorithm comprises a neuronal network,
the device for predicting further comprising training means configured to train the neuronal network to identify the defect of the bearing and to extract geometrical parameters of the identified defect from pictures stored a reference data base.

8. The device for predicting according to claim 6, further comprising generating means configured to generate a recommendation according to the predicated evolution of the identified defect.

9. A system for predicting the evolution of a defect of a bearing comprising a device for predicting according to claim 6 and a mobile device configured to take the picture of the bearing while the bearing is mounted in a machine and configured to communicate wirelessly with the device for predicting.
